(19) United States
(12) Patent Application Publication
(10) Pub. No.: US 2007/0237144 A1
(43) Pub. Date: Oct. 11, 2007

(54) Transporting authentication information in RTP

(75) Inventors: Akshay Adhikari, Basking Ridge, NJ (US); Sachin Garg, Green Brook, NJ (US); Anjur S. Kishnakumar, Rocky Hill, NJ (US); Navjot Singh, Denville, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology LLC

(21) Appl. No.: 11/393,212

(22) Filed: Mar. 30, 2006

(51) Int. Cl. H04L 12/56

(52) U.S. Cl. 370/392

(57) ABSTRACT

A method of transporting authentication information in a media stream packet includes embedding the authentication information in one of a heading and a payload of the media stream packet.

### BACKGROUND OF THE INVENTION

The present invention relates to transporting an authentication code in an RTP packet.

The Real-Time Transport Protocol (RTP) is an Internet protocol standard that specifies a method for programs to manage real-time transmission of multimedia data. RTP is commonly used with Internet telephony. The Secure Real-Time Transport Protocol (SRTP) defines a profile of RTP intended to provide encryption, message authentication and integrity, and replay protection to RTP data such as, for example, Voice over Internet Protocol (VoIP).

As VoIP deployments become more prevalent, DoS attacks against them have become a cause for concern. The functioning of VoIP devices can be impaired by sending fake RTP packets, which, if spoofed properly, are played back resulting in degraded audio quality. To prevent the deleterious results of DoS attacks, SRTP is used to secure VoIP streams. However, the protection afforded by SRTP comes with a cost. Authentication in SRTP is generally performed by attaching an authentication tag to the message to be sent. The tag is calculated using a cryptographically secure hash algorithm, such as HMAC−SHA1. The recipient of the message must recompute the tag for every message received, and verify that it matches the one attached to the message. Accordingly, the authentication requires substantial computational resources. An attacker can exploit this substantial use of computational resources to launch a Denial of Service (DoS) attack by flooding a telephony device with fake packets causing CPU cycles to be wasted in authenticating and rejecting the fake packets. Depending on the processing power of the telephony device, it is possible to impair its regular functioning with a rate of fake packet traffic that is significantly lower than the device's network capacity.

To overcome this problem, patent application Ser. No. (Attorney Docket No. 5123-48) discloses a scheme for using simple comparisons for authentication. Hash computation is performed only for legitimate packets. Each RTP packet contains an authentication code which is unique to each packet for the duration of the call. However, that scheme requires the authentication code (usually 32 bits) to be transported to the receiver in each RTP packet.

### SUMMARY OF THE INVENTION

An object of the present invention is to provide a method for embedding authentication bits in an RTP packet.

The object is met by a method of transporting authentication information in a media stream packet, which includes the step of embedding the authentication information in one of a header and a payload of the media stream packet.

The step of embedding may, for example, include turning on a header extension bit which adds two 32 bit fields to a real time transport protocol packet, and adding the authentication information in the second of the two 32 bit fields.

Alternatively, the step of embedding may include turning on a padding bit which indicates the presence of extra bytes after the payload, and adding a pad including the authentication information at the end of the payload. The pad may further include an additional byte indicating a length of the pad.

In yet another embodiment, the step of embedding includes replacing a synchronization source identifier field of a real time transport protocol header with the authentication information.

A further embodiment includes generating a 32 bit XORed result of a time stamp of the real time transport protocol packet and replacing a time-stamp field of the real time transport protocol header with the 32-bit XORed result.

In yet another alternative embodiment, the step of embedding comprises watermarking the payload, i.e., replacing chosen bits of the payload of the real time transport protocol packet with the authentication code.

The method may further include the steps of agreeing, by a sender and receiver, on a shared secret, and computing a first sequence of numbers at the sender using the shared secret and computing a second sequence of numbers at the receiver using the shared secret, wherein the step of embedding includes embedding successive numbers of the first sequence in successive messages by the sender.

The media stream packet may be an RTP packet.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a flow diagram of the steps for communicating an RTP media stream according to the present invention;

FIG. 2 is a sequence diagram showing the flow of information between a sender and a receiver for communicating the RTP media stream according to FIG. 1;

FIG. 3 is an illustration depicting the various fields of a header of a real time transport protocol packet;

FIG. 4 is an illustration depicting various fields of a header of a real time transport protocol packet; and

FIG. 5 is a schematic diagram of a network in which the present invention is implemented.

### DETAILED DESCRIPTION OF THE PRESENTLY PREFERRED EMBODIMENTS

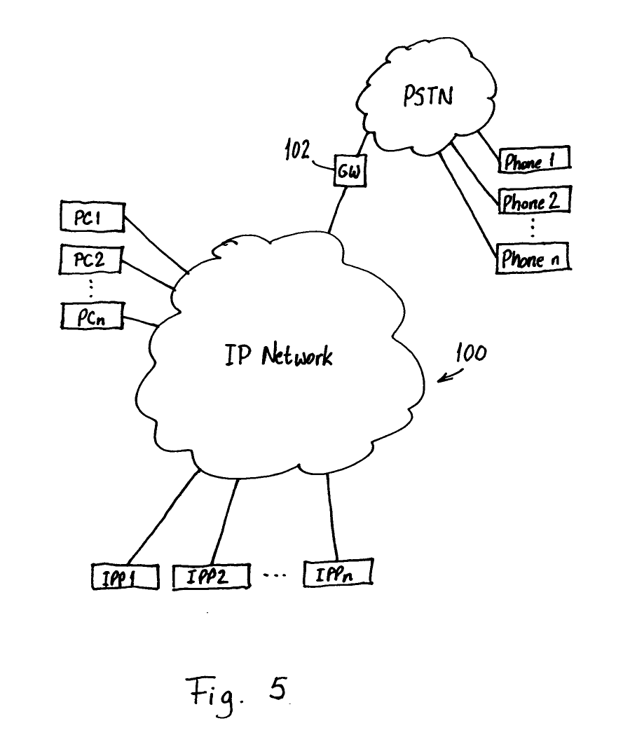

The present invention relates to a method for transporting communication packets, specifically RTP media stream packets between two network endpoints, i.e., a sender and a receiver. FIG. 5 is a simplified network showing various types of endpoints that may be connected to an IP Network 100 such as, for example, the Internet. The various endpoints include personal computers PC1, PC2, . . . PCn, IP Phones IPP1, IPP2, . . . IPPn, and phones P1, P2, . . . Pn. The personal computers PC1, PC2, . . . PCn, IP Phones IPP1, IPP2, . . . IPPn are directly connected to the IP network 100 by a service provider. The phones P1, P2, . . . Pn are connected to a Public Switched Telephone Network (PSTN) which is connected to the IP Network 100 by a gateway 102. The method described below can be performed on an RTP media stream between any two of the endpoints shown in FIG. 5 such as, for example, Voice over Internet Protocol (VoIP) streams. The communication between the two endpoints may be a full duplex. However, only one direction of communication will be described below. The same method applies to the reverse direction.

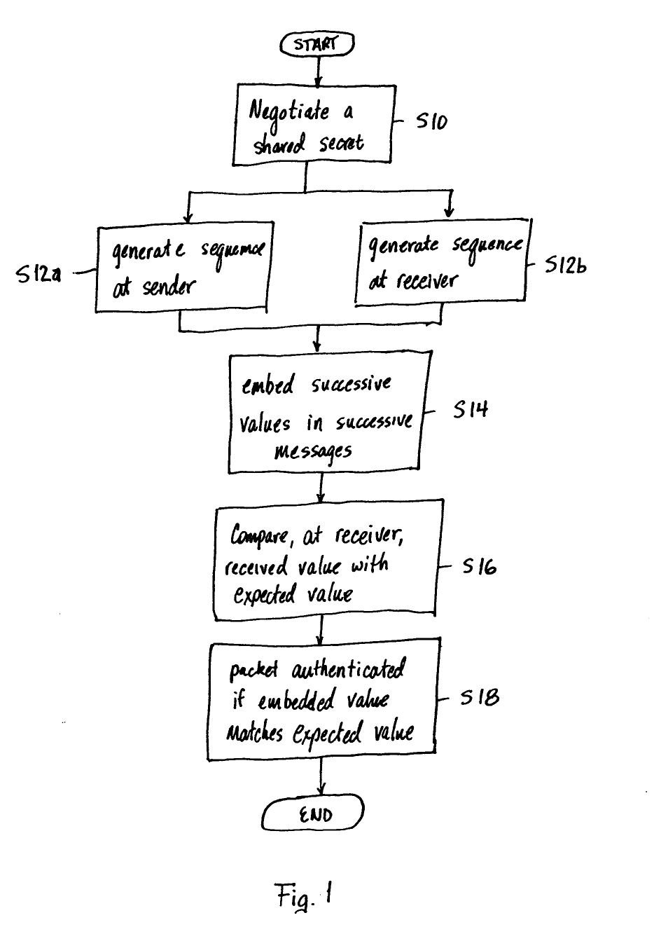

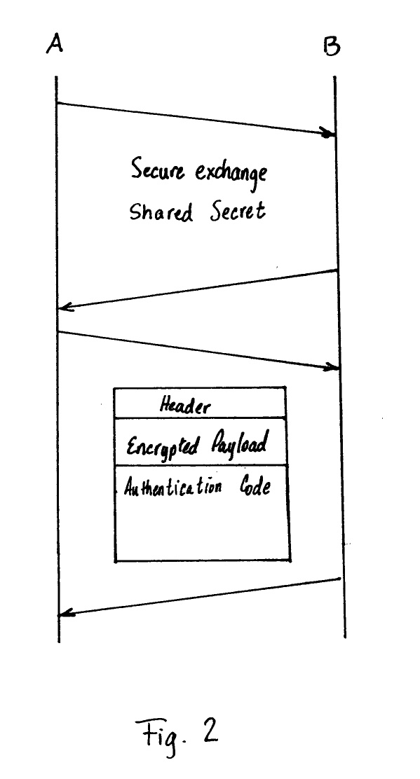

FIGS. 1 and 2 show the general steps of a method for communicating an RTP media stream between two network endpoints which is described in more detail in copending application Ser. No. (Attorney docket 5123-48), the entire contents of which is incorporated by reference. According to FIGS. 1 and 2, sender A and receiver B agree on a secret such as, for example, a secret key K and a seeding hash Hₛ for a hash algorithm or a shared key for a Pseudo Random Number Generator (PRNG), step S10. At steps S12a and S12b, the sender and the receiver each independently compute a sequence of numbers Na and Nb from the shared secret. The sequences are the same such that Na=Nb. The sequence is referred to hereafter as sequence Ns and is cryptographically secure so that no other party can generate Ns without knowledge of the shared secret. Furthermore, an attacker should not be able to generate some or all of the elements of Ns given knowledge of the some of the elements of Ns. More specifically, the would-be attacker should not be able to generate Ns(i+1), if the attacker knows Ns(i). One example of a suitable sequence Ns is a sequence of hashes is generated using a cryptographically secure hash algorithm hash( ) such as HMAC−SHA1, wherein the hash values are computed as follows:
H₀=Hash(Hₛ,K), and
Hᵢ32 Hash(Hᵢ₋₁,K) for I>=1.

The hash algorithm HMAC−SHA1 computes 20 byte hashes. However, the hash values used may be truncated to a smaller length L, such as, for example, by using the first L bits of the 20 byte hash. Alternatively, the sequence Ns could be a sequence of numbers generated by a PRNG using a key that is used for AES encryption.

The sender embeds successive hashes of the sequence in the successive messages sent to the receiver, step S14. Since the receiver knows which packet to expect next in the stream, the receiver compares the hash of the received packet with the expected hash (which the receiver has already computed), step S16. Once the packet is authenticated by matching the hash of the received packet with the expected hash, step S18, the receiver can replace the expected hash with the next one in the sequence. Once the packet is authenticated, it can be passed onto the SRTP layer.

Step S14 of the above described method requires that each RTP packet must transport authentication information, i.e., the number associated with that packet from the sequence of numbers generated. The copending application (attorney docket no. 5123-48) discloses appending the authentication information in SRTP. The following description discloses five specific embodiments for embedding the authentication information in the packet instead of appending the authentication information: 1. Use of Header Extension; 2. Use of Padding in RTP Payload; 3. Use of SSRC Field in RTP Header; 4. Use of Time Stamp Field in RTP Header; and 5. Payload Watermarking.

Header Extension

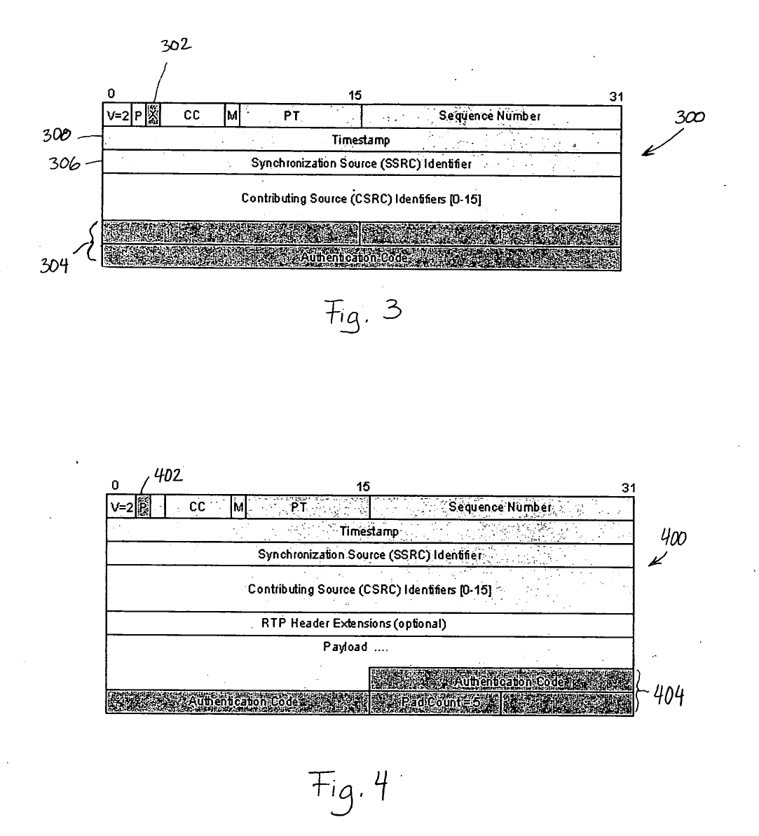

FIG. 3 illustrates the various fields of an RTP header 300. According to a first embodiment of the present invention, a header extension bit 302 is turned on, i.e., set to one, and two 32 bit fields 304 are added to the original RTP header immediately after the contributing source identifier (CSRC) fields, if any. The first 32 bits of the header extension 304 are mandated by the RTP standard, out of which 16 bits are used to specify the count of following 32 bit fields. In our case, this would be set to 1. The second 32 bits of the header extension carries the actual authentication code or authentication information. This approach is transparent to use of encryption since the header 300 is transmitted in the clear. The same holds for SRTP. However, extra bandwidth is required because the header 300 is expanded by 64 bits and in the case of 20 millisecond packetization interval, an extra 3.2 Kbps bandwidth is consumed. Unaware endpoints cannot be supported, as compliance requires processing of header extensions. RTCP behavior remains unchanged.

Padding in RTP Payload

FIG. 4 discloses another RTP header 400 using a different approach for embedding the authentication information according to another embodiment of the present invention. The RTP header 400 includes a padding bit 402. When this bit is turned to one, it indicates the presence of extra (padding) bytes, i.e., a pad 404, following the payload. According to the present invention, the pad 404 contains the 32 bits of authentication information as well as an additional byte which carries the value “5” indicating that the pad length is 5 bytes.

The addition of the authentication information as a padding can be used with encryption only if the cipher block size is such that it does not require any padding itself. The recommended ciphers in SRTP indeed have this property where the payload size is an integer multiple of the cipher block size. If this were not true, then the padding required for encryption cannot be distinguished from the pad that carries authentication. The bandwidth usage is increased in this case as well, but to a slightly lesser extent than with the header extension approach. For the same example of 20 millisecond packetization interval and 32 bit authentication code, a 40 bit pad is needed which includes the 1 byte pad length, resulting in 2 Kbps extra bandwidth. RTP compliant legacy devices, although would not have the DoS resiliency provided by authentication, they should work correctly as the padding bytes will be ignored. RTCP behavior remains unchanged by implementation of this embodiment.

SSRC Field

The RTP header 300 in FIG. 3 also contains a 32 bit field called SSRC (synchronization source identifier) 306. The main purpose of SSRC is to uniquely identify packets belonging to a sender in one RTP session. In other words, the value of the SSRC field determines the originator of the RTP packet. To achieve uniqueness a sender generates a 32 bit random number, which is then sent in each RTP packet from that sender, as a SSRC in a session. According to a further embodiment of the present invention, the constant SSRC value in this field is replaced by the authentication information, which authenticates the originator of the RTP packet, which is exactly the goal of the SSRC field. As described above with respect to FIGS. 1 and 2, the authentication information is a deterministic sequence of random numbers that can be generated only by the sender and the receiver. So, rather than checking for the same SSRC value in the 32 bit field, in this case, the receiver checks for values from a known sequence of pseudo random numbers. The method according to this embodiment is powerful as it achieves both data origin authentication and classification of RTP packets. The data origin authentication is achieved in that an attacker does not have the knowledge of the pseudo random number sequence (unique PRN in each packet) and hence can not spoof this field as opposed to the use of a fixed value as in the original SSRC. The classification of RTP packets is achieved in that a receiver participating in multiple RTP sessions or receiving from multiple senders in a single session can distinguish between the packets belonging to each stream correctly, which is the original goal of the SSRC field.

Since the header is sent in clear, payload encryption will work transparently. Conceptually, SRTP also is not affected. However, some implementation changes may be needed as the specification uses the SSRC field (as one of many parameters) to maintain the cryptographic context of each RTP session and to determine the context of an incoming RTP packet. There is no change in the bandwidth usage as no additional bits are added. One limitation with using SSRC field is that the authentication code cannot exceed 32 bits. Legacy end points will not work correctly as they expect a fixed value, which is used to determine the RTP session the incoming packets belong to. With this approach, each RTP packet will be determined to belong to a different session. The associated reporting protocol, RTCP will also need changing as the sender and receiver reports are classified based on the fixed SSRC value. A quick fix is to use the first authentication code (random number) from the sequence as the identifier in sender and receiver reports. Regardless of the heuristic used to choose the identifier, the main requirement is that the heuristic should be known a-priori or negotiated at call-establishment between the communicating end-points. Another limitation of using the SSRC field is that it is incompatible with processes that rely on the constancy of header fields (or lower order differences thereof) to identify sessions. Such identification may be necessary, for example, to provide header compression, or resource provisioning for QoS.

Time-Stamp Field

Yet a further embodiment uses the time-stamp field 308 of a real time transport packet header 300. The time-stamp field 308 is a 32-bit field that carries values from a monotonic, linear clock, which is sampled to mark the first octet of data in each RTP packet. For instance, with a 20 millisecond packetization interval, and G.711 codec, each successive RTP packet has a time-stamp which increments by 160 since each such RTP packet contains 160 octets (audio samples).

To use the time stamp field, the initial time stamp must first be obtained. The initial time stamp may be exchanged along with the shared secret. Alternatively, the expected authentication code of the first packet may be XORed with the authentication information on the receiving side to obtain the initial time stamp. In the latter case, the initial time stamp is accepted if SRTP authentication succeeds.

The time stamp field may be used as follows. The sender generates the time-stamp value as before and also the 32-bit authentication information. Then the 32-bit XORed result of the time-stamp and the authentication information is placed in the 32-bit time-stamp field and transmitted. Since the expected authorization code in an incoming packet is known, an XOR with the authentication information yields the original time-stamp. Alternatively, an XOR with the expected time-stamp yields the authentication information, which can be compared with the expected code to authenticate the packet.

Payload encryption does not affect this embodiment which uses the time stamp field. This embodiment should also work with SRTP transparently. One limitation is that the authentication code has to be exactly 32 bits (or less with known padding). The bandwidth usage remains the same as with original RTP since no extra bits are added. Legacy devices may not work correctly, since time-stamp field is used for synchronization as well as for calculation of jitter and loss. These calculations remain unaffected in aware devices as the original time-stamp is recovered after the packet is authenticated. In other words, RTCP operation does not need to be altered for these devices.

Payload Watermarking

Yet another embodiment to embed the authentication includes using watermarking, a known technique to embed additional information in digital data. The key requirement in watermarking is that the change in the original message/data should not be perceptible. One of the ways to embed information (watermark) digital data is by bit-robbing, where some of the bits in the original message are replaced by the watermark bits. As mentioned before, the modification does not perceptibly change the information contained in the original data. In this embodiment, the authentication bits are carried in an RTP packet, where chosen bits of the RTP payload are replaced by the authentication code. It has been shown that for G.711 codec with 20 millisecond packetization interval (which is typical of commercial VoIP systems), replacing up to 80 bits in the original 160 byte payload has no perceptible change in audio. The authentication bits are uniformly distributed within the payload to reduce cyclic artifacts in resulting audio. The paper studied the worst case behavior, where the least significant bits (LSBs) of some or all of the 160 bytes were flipped and the resulting audio analyzed for perceptible deviations from the original speech. In reality the replacement, on average, will only change half the bits.

If the RTP payload is encrypted, then the authentication bits may be substituted before or after the encryption at the sender side. In the former case, the only limitation is that the overhead of decryption will be incurred before authentication can take place. With respect to SRTP, which specifies the use of AES stream cipher (counter mode), a simple XOR of only the relevant bit positions with the key-stream will yield the authentication bits. Hence, the overhead is likely minimal. If the authentication bits are substituted after encryption, this would work only if a proper cipher is used. Again, with SRTP, this is not an issue as a stream cipher is used which involves XOR of corresponding bit positions with the key-stream. Bandwidth consumption remains the same as no additional bits are added. The approach is fully transparent to legacy devices as they will interpret all bits in the payload as part of coded audio, which will be decoded and played out. In fact, the audio change will not be perceptible to the human listener at the receiver end. This approach does not require any modification to RTCP and should work transparently with current compliant RTCP implementations.

Each of the above examples is described relative to use with media stream RTP packets. However, these techniques may also be used for many other protocols. For example, the use of the SSRC field may be used in any protocol where the same session identifier is used across packets. Replacing this identifier with a sequence of unique values where the sequence is known to only the sender and the receiver achieves the same objective as session identification with the added benefit that data-origin authentication is possible. If authentication/security is not of concern, then the sequence of values may be publically known.

The audio watermarking approach can be generalized for uses besides authentication. Two key properties of the watermarked audio packets are (1) the embedded information receives the same network priority as the RTP packets, which is usually higher than best-effort data traffic, and (2) the embedded information can be synchronized with the audio payload.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of transporting authentication information in a media stream packet, comprising the step of embedding the authentication information in one of a header and a payload of the media stream packet.

2. The method of claim 1, wherein said step of embedding comprises:
turning on a header extension bit which adds two 32 bit fields to the real time transport protocol packet; and
adding the authentication information in the second of the two 32 bit fields.

3. The method of claim 1, wherein said step of embedding comprises:
turning on a padding bit which indicates the presence of extra bytes after the payload;
adding a pad including the authentication information at the end of the payload.

4. The method of claim 3, wherein the pad further includes an additional byte indicating a length of the pad.

5. The method of claim 1, wherein said step of embedding comprises replacing a synchronization source identifier field of a real time transport protocol header with the authentication information.

6. The method of claim 5, wherein the authentication information comprises a 32 bit authentication information.

7. The method of claim 1, wherein said step of embedding comprises generating a 32 bit XORed result of a time stamp of the real time transport protocol packet and replacing a time stamp field of the real time transport protocol header with the 32-bit XORed result.

8. The method of claim 7, further comprising the step of extracting, by a receiver, the authentication information by XORing with the time stamp for that packet, which is known to the receiver based on the sequence number and previously received packets.

9. The method of claim 1, wherein said step of embedding comprises replacing chosen bits of the payload of the real time transport protocol packet with the authentication code.

10. The method of claim 1, further comprising the steps of agreeing, by a sender and receiver, on a shared secret, and computing a first sequence of numbers at the sender using the shared secret and computing a second sequence of numbers at the receiver using the shared secret, said step of embedding comprises embedding successive numbers of the first sequence in successive messages by the sender.

11. The method of claim 1, wherein the media stream packet is a real time transport protocol packet.

12. A communication terminal comprising a memory storing computer-executable instructions for performing the step of embedding authentication information in one of a heading and a payload of a media stream packet to be sent to a receiver.

13. The communication terminal of claim 12, wherein said step of embedding comprises computer executable instructions for:
turning on a header extension bit which adds two 32 bit fields to the real time transport protocol packet; and
adding the authentication information in the second of the two 32 bit fields.

14. The communication terminal of claim 12, wherein said step of embedding comprises computer executable instructions for:
turning on a padding bit which indicates the presence of extra bytes after the payload;
adding a pad including the authentication information at the end of the payload.

15. The communication terminal of claim 14, wherein the pad further includes an additional byte indicating a length of the pad.

16. The communication terminal of claim 12, wherein said step of embedding comprises computer executable instructions for replacing a synchronization source identifier field of a real time transport protocol header with the authentication information.

17. The communication terminal of claim 16, wherein the authentication information comprises a 32 bit authentication information.

18. The communication terminal of claim 12, wherein said step of embedding comprises computer executable instructions for generating a 32 bit XORed result of a time stamp of the real time transport protocol packet and replacing a time stamp field of the real time transport protocol header with the 32-bit XORed result.

19. The communication terminal of claim 18, further comprising the step of extracting authentication information from a received packet by XORing with the time stamp for the received packet, which is known based on the sequence number and previously received packets.

20. The communication terminal of claim 12, wherein said step of embedding comprises computer executable instructions for replacing chosen bits of the payload of the real time transport protocol packet with the authentication code.

21. The communication terminal of claim 12, wherein said computer executable instructions further comprise the steps of agreeing, by a sender and receiver, on a shared secret, and computing a first sequence of numbers at the sender using the shared secret and computing a second sequence of numbers at the receiver using the shared secret, said computer executable step of embedding comprises embedding successive numbers of the first sequence in successive messages by the sender.

22. The communication terminal of claim 10, wherein the media stream packet is a real time transport protocol packet.
